(19) United States
(12) Patent Application Publication
(10) Pub. No.: US 2007/0029385 A1
(43) Pub. Date: Feb. 8, 2007

(54) Multi-planar radio frequency identification device

(76) Inventors: F. Gary Kovac, Sewikley, PA (US); John J. Craig, Gibsonia, PA (US)

Correspondence Address: DILWORTH & BARRESE, LLP, 333 EARLE OVINGTON BLVD., UNIONDALE, NY, 11553, US

(21) Appl. No.: 11/500,203

(22) Filed: Aug. 7, 2006

Related U.S. Application Data
(60) Provisional application No. 60/705,834, filed on Aug. 5, 2005.

(51) Int. Cl. G06K 7/00

(52) U.S. Cl. 235/435; 340/572.7

(57) ABSTRACT

A radio frequency identification device includes at least two, and preferably three, panels oriented at an angle to each other, each panel including a planar antenna disposed thereon, said panels including means for attachment to a container. The radio frequency panels are preferably each oriented along a plane orthogonal to the other panels.

### CROSS-REFERENCE TO RELATED APPLICATIONS

This application claims priority to U.S. Provisional application Ser. No. 60/705,834 filed Aug. 5, 2005, to which priority is claimed, and which is herein incorporated by reference in its entirety.

### BACKGROUND

1. Field of the Invention

The present invention relates to radio frequency identification devices (RFIDs), and particularly to RFID tags.

2. Background of the Art

Wireless communications using miniature devices is currently a most active technological development area. It is anticipated that while garage openers, cell phones, radio control of model airplanes, etc., are valuable use of the technology, a gigantic opportunity has emerged and will/may be the UPC pricing code one day, along with inventory control. Antenna methodology has been and will be directed towards improvement for the next several years to facilitate wireless communication.

Various improvements in antenna design and manufacture have been attempted. For example, U.S. Pat. No. 6,870,516 to Aisenbrey discloses low cost antennas using conductive plastics or composites.

U.S. Pat. No. 4,849,765 discloses a low profile, printed circuit board antenna for operating in the 800 to 900 mHz range and especially suited for use with portable, hand-held electronic apparatus. The antenna features printed circuit board construction for precision fabrication, broadband operations and enhanced efficiency. The antenna includes a driven element in close association with a parasitic element printed on one surface of the printed circuit board in a side-by-side, parallel relation. A conductive strip is included on the other side of the board spanning the free ends of the driven and parasitic elements to enhance the coupling there-between. This low profile antenna can be used with hand held electronic apparatus. But also the approach could apply to an expensive RFID construction.

U.S. Pat. No. 6,838,989 discloses a RFID transponder having active backscatter amplifier for re-transmitting a received signal.

Wireless communication system that communicate signals over the RF spectrum are well known in the art. Such systems have numerous diverse applications, including cordless and cellular telephones, paging, wireless computer networks, mobile radio for police, fire and municipal services, remote control devices for garage doors and other devices, and remote data sensing, to name just a few. A drawback of all such communication systems is that the radiated power becomes attenuated over distance.

Accordingly, it is known to introduce one or more amplifier units between a source and destination of an RF signal, known as repeaters. Such repeater stations amplify and retransmit a received signal in order to make up for the power loss between the source and destination. Repeater systems are advantageous for many applications.

Another drawback is that it is necessary to maintain isolation between receiving and transmitting antennas of the repeater system in order to avoid interference between the received and transmitted signals.

One wireless communication application that is particularly sensitive to such range limitations and the drawbacks of conventional repeaters is radio frequency identification (RFID) technology. In the automatic data identification industry, the use of RFID transponders (also known as RFID tags) has grown in prominence as a way to track data regarding an object to which digital information may be stored, such as electrically erasable, programmable read-only memory (EEPROMs) or similar electronic memory modulation,” the RFID transponders transmit stored data by reflecting varying amounts of an electromagnetic field provided by an RFID interrogator by modifying their antenna matching impedances.

The RFID transponders may either extract their power from the electromagnetic field provided by the interrogator, or alternatively, may include their own power source. RFID transponders that include a power source are particularly advantageous in applications in which maximum range is desired, such as in remote vehicle toll collection and transportation monitoring. Notwithstanding this performance advantage of battery-powered RFID transponders, there is a continuing demand to further increase the range at which such RFID transponders can communicate without having to make associated increases in size, weight and cost of the RFID transponders.

Accordingly, it would be very desirable to provide a method for increasing the effective range of an RFID transponder as well as for other types of RF communication systems without increasing the size, weight or cost of the transponder.

### SUMMARY

A radio frequency identification device is provided herein which comprises at least two, and preferably three, panels oriented at an angle to each other, each panel including a planar antenna disposed thereon, said panels including means for attachment to a container. The radio frequency panels are preferably each oriented along a plane orthogonal to the other panels.

### BRIEF DESCRIPTION OF THE DRAWINGS

Various embodiments are described below with reference to the drawings wherein:

FIG. 1 is a perspective view illustrating the RFID device of the invention folded into a three dimensional configuration and attached to the corner of a container; and,

FIG. 2 is a plan view illustrating the RFID device of the invention fabricated as a flat sheet which can be subsequently folded into the three dimensional configuration.

### DETAILED DESCRIPTION OF PREFERRED EMBODIMENT(S)

The passive RFID tag (or, transponder) orientation to the reader is the most critical factor that determines whether the tag can capture enough energy to result in a positive read. Traditional tags are flat with single plane orientation and consequently if the tag happens to be parallel to the energy field, the energy will pass over the tag and result in no read. In many cases, due to environmental issues, the tag will not be read, even if the angle of antenna orientation is something less than perpendicular to the energy field. The closer the tag is to the energy field, the greater the probability that the RFID tag antenna will be able to capture enough energy by its capacitor to activate and create a signal.

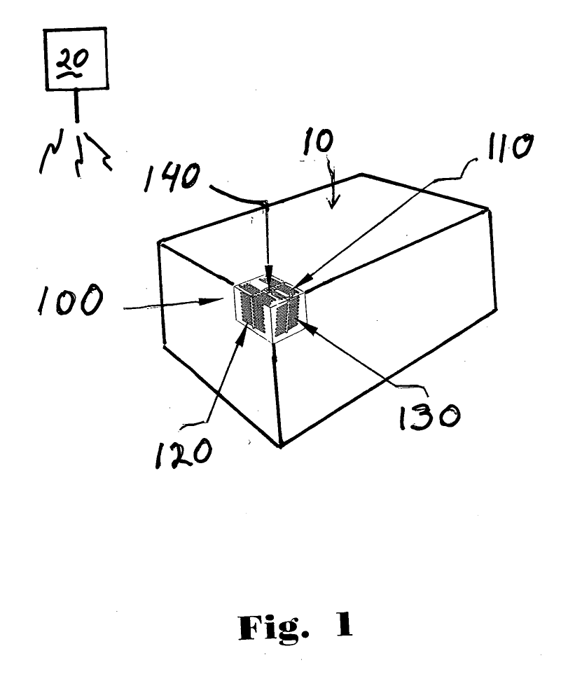

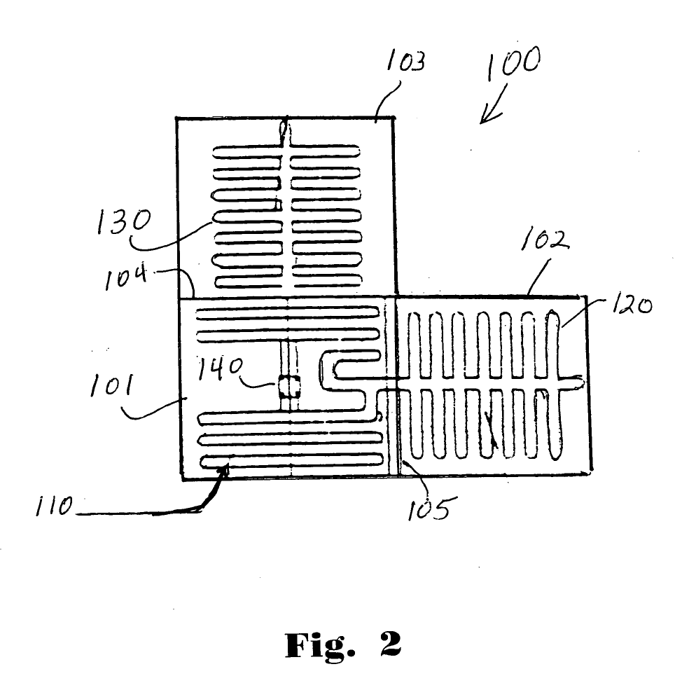

To solve the tag orientation issues and improve the probability of the RFID tag read, the corner tag of the instant invention, shown in FIGS. 1 and 2, creates a multiplanar, three dimensional antenna orientation, which highly increases the probability of a positive read. Any three dimensional antenna tag is included in the scope of this invention. The three dimensional corner tag can be created in various sizes to accommodate any size shipping container, box or any three dimensional box. Each of the three sides of the tag/label will accommodate an antenna that will capture the energy to be supplied to a common IC (integrated circuit) or die.

Because of the multi dimensional antenna's orientation, the RFID tag's capacitor receives energy in varying amounts from each antenna, based on the changing position of the host package, as it moves thru the supply chain. Due to the increased probability of the multiple power supplies, the nature of instant invention results in substantially better read reliability. Additionally, the greater power supply capability, created by the corner tag will also pave the way for development of more powerful integrated circuits.

Referring now to FIGS. 1 and 2, the multiplanar RFID device of the invention 100 includes three connected flat panel 101, 102 and 103 and three planar antennas 110, 120 and 130, each planar antenna being disposed along a respective one of the three panels 101, 102 and 103.

The flat panels 101, 102 and 103 are connected at fold lines 104 and 105 as shown in FIG. 2. The RFID device 100 can be fabricated as a flat L-shaped member made of paper, polymeric film or any other suitable flat sheet material as shown in FIG. 2 and then folded along fold lines 104 and 105 to form a three dimensional structure with each antenna oriented along a plane orthogonal to the other antennas.

The RFID device 100 can be attached to and folded around a corner of a container 10 to facilitate inventory management. In a preferred embodiment panels 101, 102 and 103 include an adhesive to facilitate application of the RFID device 100 to the outside surface of the container 10. Alternatively, the RFID device 100 can be packaged within the container or attached to the inside surface of a container wrapper or covering, especially at a corner thereof. Adhesive formulations suitable for use in the invention are known in the art.

The antennas 110, 120 and 130 can be any type of antenna known in the art which is suitable for use in RFID devices. Moreover, the antennas can be fabricated by applying a patterned conductive coating as a fluid which is then dried, for example by evaporation of a solvent or by curing a matrix resin loaded with conductive filler (e.g., by UV curing, thermal curing, etc.) The coating can be applied by standing printing techniques, such as silk screen printing, offset and the like. Such coatings are known in the art.

Referring to FIGS. 1 and 2, the RFID device 100 can also include an integrated circuit (IC) chip 140 connected to the antennas 110, 120 and 130 which is capable of storing digital information. Optionally, the RFID device can be passive (without an internal energy source), or active (i.e., with a battery or other such internal source of energy.

When affixed to containers such as illustrated in FIG. 1, the RFID device 100 is able to interact with a standard RFID reader at any direction or orientation because of the three dimensional configuration of the antennas.

While three orthogonally oriented planar antennas are preferred, the RFID device can comprise two planar antennas oriented at an angle to each other of from 10° to 90° preferably 45° to 90°.

Accordingly a system for inventory management includes the RFID device of the invention 100 mounted to containers 10 and at least one RFID reader device 20 which picks up signals from the RFID device and which can be connected to a control unit for automatically detecting and identifying the individual containers 10, storing and processing information about the containers 10, and directing the transfer or movement of the containers to specified destinations within, for example, a warehouse.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A radio frequency identification device which comprises:
at least two panels oriented at an angle to each other, each panel including a planar antenna disposed thereon, said panels including means for attachment to a container.

2. The radio frequency identification device of claim 1 wherein said device includes three panels, each oriented along a plane orthogonal to the other panels and each panel including a planar antenna disposed thereon.

3. The radio frequency identification device of claim 1 further including an integrated circuit chip.

4. The radio frequency identification device of claim 1 wherein the panels are fabricated from paper.

5. The radio frequency identification device of claim 1 wherein the antennas are each fabricated from a patterned conductive fluid applied to the panels and dried.

6. The radio frequency identification device of claim 1 wherein said means for attachment includes an adhesive.

7. A system for inventory management including:
a) a radio frequency identification device reader;
b) at least one radio frequency identification device which includes three panels, each oriented along a plane orthogonal to the other panels and each panel including a planar antenna disposed thereon to form a three dimensional configuration, said at least one radio frequency identification device being attached to a container.

8. The system of claim 7 wherein the radio frequency identification device is attached to a corner of the container.

9. The system of claim 7 wherein the radio frequency identification device is a passive device energized by the radio frequency identification device reader.

10. The system of claim 7 wherein the radio frequency identification device includes an internal energy source.

11. A method for managing inventory comprising the steps of:
a) providing at least one radio frequency identification device which includes three panels, each oriented along a plane orthogonal to the other panels and each panel including a planar antenna disposed thereon to form a three dimensional configuration, said radio frequency identification device including an integrated circuit;
b) affixing said radio frequency identification device to a container;
c) scanning said container with a radio frequency identification device reader; and
d) detecting and identifying said container.

12. The method of claim 11 further including storing and processing information about the container and directing the transfer or movement of the container to a specified location.

13. The method of claim 11 wherein step (a) comprises fabricating the radio frequency identification device by applying a configured fluid conductive coating to a flat substrate to provide three antennas, each antenna being disposed in a respective one of three panel areas, said panel areas being joined at intermediate fold lines, and folding the substrate at the fold lines to configure the panel areas into the three orthogonal panels.

14. The method of claim 13 wherein the step of applying the fluid conductive coating to the substrate is performed by silk screen or offset printing.

15. The method of claim 14 wherein the substrate is paper or polymer film.

16. The method of claim 13 wherein the substrate includes an adhesive backing and step (b) of affixing the radio frequency identification device to the container is accomplished by adhesive bonding.

17. The method of claim 11 wherein the radio frequency identification device is a passive device and step (c) of scanning the container includes energizing the radio frequency identification device by means of radio frequency energy emitted by the scanner.
